(19) United States
(12) Patent Application Publication
(10) Pub. No.: US 2010/0099070 A1
(43) Pub. Date: Apr. 22, 2010

(54) METHOD AND APPARATUS FOR AGGREGATING, PRESENTING, AND MANIPULATING DATA FOR INSTRUCTIONAL PURPOSES

(75) Inventors: Albert L. Abrahamson, Yorktown, VA (US); Corey E. Brady, Weston, FL (US); Mark D. Fry, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/582,856

(22) Filed: Oct. 21, 2009

Related U.S. Application Data
(60) Provisional application No. 61/107,187, filed on Oct. 21, 2008.

(51) Int. Cl. G09B 7/00; G09B 19/00

(52) U.S. Cl. 434/350; 434/362; 434/188

(57) ABSTRACT

A method and apparatus for aggregating data for instructional purposes. The method includes retrieving student responses, determining at least one bucket type and, if needed, changing the algorithmic criteria defining the at least one bucket type, aggregating the responses according to bucket type, and utilizing the aggregated responses for instructional purposes.

### CROSS-REFERENCE TO RELATED APPLICATIONS

This application claims benefit of U.S. provisional patent application Ser. No. 61/107,187, filed Oct. 21, 2008, which is herein incorporated by reference.

### BACKGROUND OF THE INVENTION

1. Field of the Invention

Embodiments of the present invention generally relate to a method and apparatus for aggregating, presenting, and manipulating data for instructional purposes.

2. Description of the Related Art

Major problems for a teacher in teaching a class of students are soliciting, observing, assimilating, and adapting to what every student thinks in a timely fashion. This is particularly true in “cumulative knowledge” subjects, such as, mathematics and science where students may have failed to fully grasp key concepts, or may hold misconceptions that are difficult for a teacher to detect, but which can severely inhibit their learning.

Networked classroom systems, such as, TI-Navigator & simpler “Clicker-type” systems, help solve this problem by providing rapid gathering, aggregation, and display of student responses. These types of systems are limited when answers to questions are not in multiple choice form or the answers are limited to a defined set of choices. For example, the simpler “Clicker-type” systems only allow highly structured responses, such as, multiple choice or numeric answers to a question. More advanced systems (such as TI-Navigator 3.0), which allow for student responses with complex structures, such as, mathematical expressions or equations, are limited to provide simple text matching software tools to aggregate and display such answers from a class of students.

Other types of systems, such as, those for homework over the internet, also exist to gather and aggregate student work. These may provide text-matching capability and also approximate rudimentary sorting for equivalent mathematical expressions, but such systems are not intended for real-time, in-class use. For a mathematics or science teacher, there currently is no comprehensive solution to the need for in-class live-search and display of patterns in student responses, with aggregation into mathematically or conceptually meaningful categories.

Some web-based homework systems, such as, e.g. “WebAssign”, allow open-ended questions with mathematical expressions as answers. These are aggregated by a simple approximate method, which involves the following steps: the expressions are parsed, variables identified, a random number set is substituted for each variable & the expressions evaluated for each point on the set. Thus, the expressions that evaluate to approximately the same values at each point in the set are taken to be equivalent expressions.

Mathematically speaking, this process is limited in more than one respect. First, it is subject to errors from rounding in the computations and from sampling in the variable domains. In other words, for absolute correctness, the number of points, in each the sets of random numbers representing each variable need to approach infinity. In addition, such method is useless in searching for patterns in student answers, because it is simply a computation; it is not based on a real analysis or “understanding” of the actual mathematics.

Therefore, there is a need for an apparatus and/or method that can be implemented in a networked classroom system and that provides the means for a teacher to analyze student responses to questions or problems, in conceptually meaningful ways and display these analyses in real time to the class. Thus, such a tool would allow a teacher to provide formative assessment information, invigorate discussion and/or improve instruction to the class.

Therefore, there is a need in the fields of mathematics and science teaching, for an improved method and/or apparatus for aggregating student response data for instructional purposes.

### SUMMARY OF THE INVENTION

Embodiments of the present invention generally relate to a method and apparatus for at least one aggregating, presenting, and manipulating mathematical data for instructional purposes. The method includes retrieving student responses, determining at least one bucket type and, if needed, changing the algorithmic criteria defining the at least one bucket type, aggregating the responses according to bucket type, and utilizing the aggregated responses for instructional purposes.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. It is also to be noted that a computer readable medium is any medium that is utilized by a computer for data executing, archiving, storage, deletion or the like.

FIG. 1 is an embodiment of an aggregation of data in accordance with the present invention;

FIG. 2 is another embodiment of an aggregation of data in accordance with the present invention; and

FIG. 3 is an embodiment of a method for aggregating, presenting, and manipulating data for instructional purposes;

FIG. 4 depicts an embodiment of a system for acquiring data for instructional purposes; and

FIG. 5 depicts an embodiment of an apparatus for aggregating, presenting, and manipulating data for instructional purposes.

### DETAILED DESCRIPTION

Described herein is method and apparatus for aggregating, presenting, and manipulating data, such as, mathematical data, science data, and the like, for instructional purposes, wherein different embodiments are utilized to identify conceptually meaningful patterns in and across data from a class, such as, students' answers. In one embodiment, the answers consist of responses to tasks, such as, problems or questions, which may not have a pre-defined set of answers, inputs, results, outputs and the like. Such aggregation may identify data patterns, and enable classifying or sorting such data, and may also provide visual representations accordingly. For example, utilizing such aggregation a teacher would be able to display students' answers according to their “fit” with the patterns of a group.

Note that in this description, the term bin or bucket refers to a grouping of data. The aggregation utilized, search factors and subject matter, may vary according to the embodiment presented. Even though this description utilizes embodiments depicting mathematical grouping, this invention may be related to other data retrieved or received, such as, equations for chemical reactions, geometric constructions, electric circuits, free-body diagrams in mechanics, structures of molecules, operations of biological cells, and the like.

The system structure and/or hardware components, within which a teacher receives the data for instructional purposes across a large number of physical, electronic, and communications configurations. For example, a teacher may receive data from a classroom network of calculators, handheld computers, laptops, notebooks, desktops, or the like. In one embodiment, the data may be transmitted over a dedicated wired or wireless classroom network, over the internet from a “virtual” classroom, via a “homework” system, asynchronously in a distance learning context, and the like. The data may relate to a question asked, tasks or activities assigned to students, and the like. The aggregation method and/or apparatus analyzes the data for patterns, performs aggregation, allows presentation, and/or enables manipulation in similar ways.

Thus, the aggregation method and apparatus may group the data into conceptually meaningful categories for instructional purposes. Such analyses may be automatic, or they may be guided by the type of information or answer, expected based on knowledge about the question or the meaning and structure of the data. Moreover, the aggregation may be specific to a teacher's particular search criteria for this activity, task, or question. The manner in which this pattern searching and/or aggregation and/or manipulation and/or presentation, is carried out is by innovative use of intelligent parsing. For example, a mathematical parsing that may embody symbolic manipulation of, and computation with, mathematical objects. The aggregation method and/or apparatus may implement, for example, algebra software, such as, a Computer Algebra System (CAS). In one embodiment, CAS is utilized in conjunction with the intelligent parsing to detect patterns in the data received from the students of a class via a network.

In one embodiment, the sensitivity and proclivity of the pattern searching may be tailored to particular categories of problem types. In such an embodiment, the teacher may be shown data with high relevance to the students' learning and their cognitive conceptions and misconceptions.

For example, many types of problem in Algebra result in student responses that take the form of an algebraic expression. These problem types include:
a. Simplify an expression
b. Compute the product of binomials, trinomials, or polynomials
c. Write an expression which describes a given physical situation
d. Use the distributive (or associative, or commutative) property to simplify an expression
e. Simplify an expression by combining like terms
f. Write an expression for a phrase written in words
g. Simplify an expression involving nested exponentiation (positive & negative)
h. Multiply or divide expressions with exponents
i. Add or subtract polynomials
j. Verify a factorization problem

In this embodiment, analysis for learning purposes may include binning of mathematically equivalent expressions. For example: (1) the teacher asks a question, problem, or exercise, verbally, or writes it on the board, or directs students to answer a specific one from a textbook, or has it entered into the classroom network system software; (2) Students answer the question and send it in to the teacher's computer via a networked classroom system; (3) The teacher selects “expressions” from among several mathematical object types (or this may have been pre-selected in course curriculum software by the system); (4) The system sorts all student responses into bins with all answers inside each bin consisting of mathematically equivalent expressions.

For this example, the first step is to create an equation from the two expressions we wish to test for functional identity. Put one on the left hand side (LHS), insert an equal sign, and put the other expression on the right hand side (RHS). This equation is the 1^{st} argument in the parameter list for the “solve” operator:

solve(Equation,Var)®Boolean expression

This “solve” operator returns candidate real solutions of an equation. The goal is to return candidates for all solutions. However, there might be equations or inequalities for which the number of solutions is infinite. Thus true is returned if solve( ) can determine that any finite real value of Var satisfies the equation, whereas false is returned when no real solutions are found.

The “solve” operator requires a second parameter, that is, the variable we wish it to solve for. For example:

solve(x+2=0,x) x=−2

Here, we are comparing the expression “x+2” with “0”. If the answer given by the operator is anything but “true”, it means that the two expressions are not identical. The answer is the solution to the equation which is “−2”. So, the expressions are obviously not identical. For example:

solve(x+2=x,x) false; whereas,

solve(x+2=x+2,x) true

This even works for less obviously identical expressions, like,

solve(x̂(2)+2*x=x*(x+2),x) true

Depending on the refinement of the “solve” operator software, it also may work if you put a “p” for the variable as the second parameter:

solve(x̂(2)+2*x=x*(x+2),p) true

Some more examples of “solve” follow:

solve(x̂(2)+2*x+yz=yz+x*(x+2),x) true

solve(x̂(2)+2*x+yz=yz+x*(x+2),y) true

solve(x̂(2)+2*x+yz=yz+x*(x+2),z) true

solve(x̂(2)+2*x+yz=yz+x*(x+2),p) true

In another embodiment, the method and/or operator may use the “expr” operator, where,

expr(String)®expression

Returns the character string contained in String as a mathematical expression and immediately executes it.
Examples of “expr” follow:

expr(“x̂(2)+2*x=x*(x+2)”) true

expr(“x̂(2)+2*x=x̂(2)+2”) x̂2+2*x=x̂2+2

Note in this last example that the result is not simplified by “expr”.

There are many pedagogical applications for which a teacher may use such a facility for identifying equivalent expressions. For example, a teacher may wish to promote discussion of whether or not certain groups of expressions are equivalent. In this case, the teacher may select an expression of interest, perhaps from a list, or from a standard text-binned histogram, and do a “smart search” for mathematically equivalent items. If any are found then they may be highlighted in a list view, multiple whole bars in a text-binned histogram may be highlighted, or any form of display or presentation showing the results.

In one embodiment, a teacher may use such a facility for identifying equivalent sub-components of expressions. For example, a teacher may wish to highlight the difference between a common answer to a problem and the correct answer. If this difference is a parameter say “a” then the teacher can select a correct answer, move it to the smart search box, subtract “a”, and hit search. Then, all the common answers would be highlighted.

In another embodiment, the teacher may wish to illustrate the similarities or differences between a common answer and the correct one, maybe on-line in front of the class. The teacher may select the two answers under consideration and can operate on them using, for example, CAS in various ways (e.g. add them, subtract them, divide, or multiply them). Then the appropriate factor and operation may be applied and searched as described in the previous paragraph.

In another example of mathematics teaching, many types of problems involve factorization. For example the following problem types are drawn from Algebra I, for example:
a. Find a common factor
b. Factor out the greatest common factor (GCF)
c. Factor out a monomial
d. Factor a trinomial
e. Recognizing a perfect square trinomial
f. Factoring the difference of two squares
g. Factoring polynomials by grouping
h. Solving some linear equations requires factorization as a step
i. Putting an equation in “Y=” form can involve factoring
j. Finding the roots of a quadratic equation can involve factoring and/or can aid understanding the meaning of the process
k. Factoring as an aid to understanding of quadratic functions
l. Factoring as a step in simplifying radicals
m. Factoring as a step in simplifying rational functions
n. Factoring as a step in adding and subtracting rational expressions

So, briefly to set an example in which a problem from one of the above problem types might be assigned and analyzed: (1) the teacher asks a question verbally, broadcasts it, writes it on the board, directs students to answer a specific one from a textbook, has it entered into the classroom network system software, and/or retrieves it from a library of problems; (2) Students answer the question and send it in to the teacher's computer via a networked classroom system. In one embodiment, students answer the question over the internet in a live geographically distributed online class. In another embodiment, the students may answer the question which has been activated on a remote server for an online class which operates asynchronously with different students connecting at different times. In a yet another embodiment, students may answer a question that is part of a homework assignment operating on a web-based homework system. The students may answer the question via any other convenient means which provides response data to the teacher; (3) The teacher selects “factors” from among several mathematical object types (or this may have been pre-selected in course curriculum software by the system); (4) The system automatically sorts students' responses into bins with all answers inside each bin consisting of mathematically equivalent factors.

For example, factor the following expression:

2x²y−2y

To analyze student answers, there are several stages to the analysis. These require extending a typical CAS engine by adding additional functionality. For example, to analyze the above problem: 1) First, compare the students answers for functional equivalence as in mentioned above, and sort all answers into functionally equivalent bins; 2) Within each bin don't do the string equivalent test yet, rather first check each answer to see if it is factorized (i.e. consists effectively of a single term). If it is not, then this answer goes into the “Not Factorized” sub-bin within this bin of functionally equivalent answers; 3) Next, for answers that are factorized, identify the factors in each answer. The answers may have any number of factors; 4) Now, for factorized answers within each bin: group answers with the same factors into sub-bins. You can test whether two factors are the same by using the same test for functional equivalence a shown above herein. For example, for the factors

(x+1) and (1+x)

solve((x+1)=(1+x),p) true

5) If the expression is in electronic form, one may use a CAS engine to determine the correct answer, an executable application or the like. For example:

factor(2x²y−2y) 2y(x+1)(x−1)

the same process of (1) to (4) above may be utilized to flag the correct bin and sub-bin.

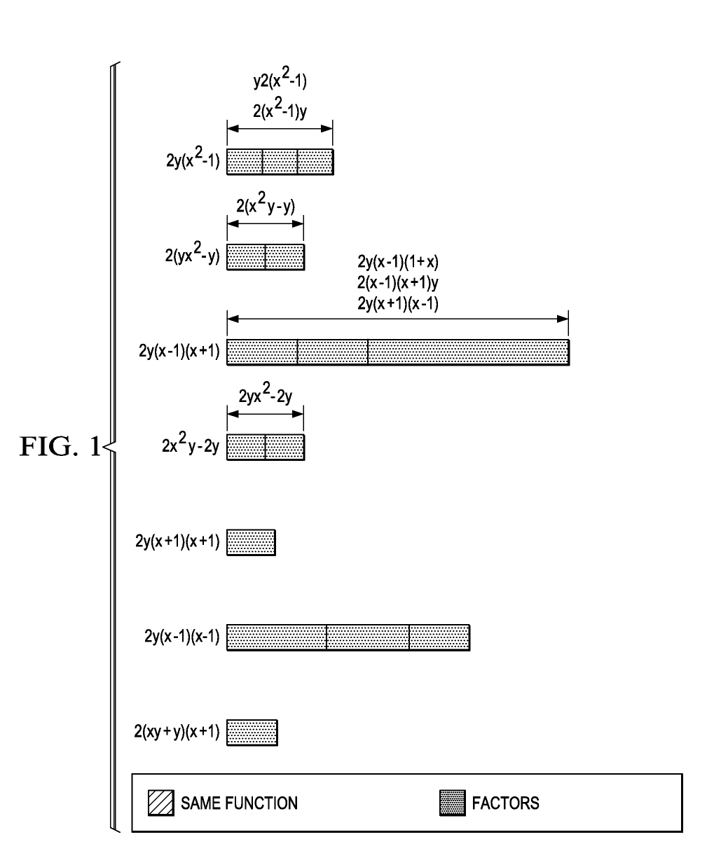

An example of a display of such information from a class, as yielded from the analysis described above, as shown in FIG. 1. FIG. 1 is an embodiment of an aggregated of data in accordance with the present invention. An analysis, such as that displayed in FIG. 1, is particularly useful for a teacher when students are learning factoring. That is, it shows which distinct factors students have obtained, with factors sets containing individual factors that are each mathematically equivalent grouped in the same bar in the histogram.

In this embodiment, factors that are not completely factored are not shown in the same bar of the histogram as ones that are completely factored. For example, as y(x²−1) is not completely factored, it is not shown in the same bar as y(x−1)(x+1) even although the two expressions are mathematically equivalent. This figure also shows expressions, which are not factored at all, in their own bars of equivalent expressions.

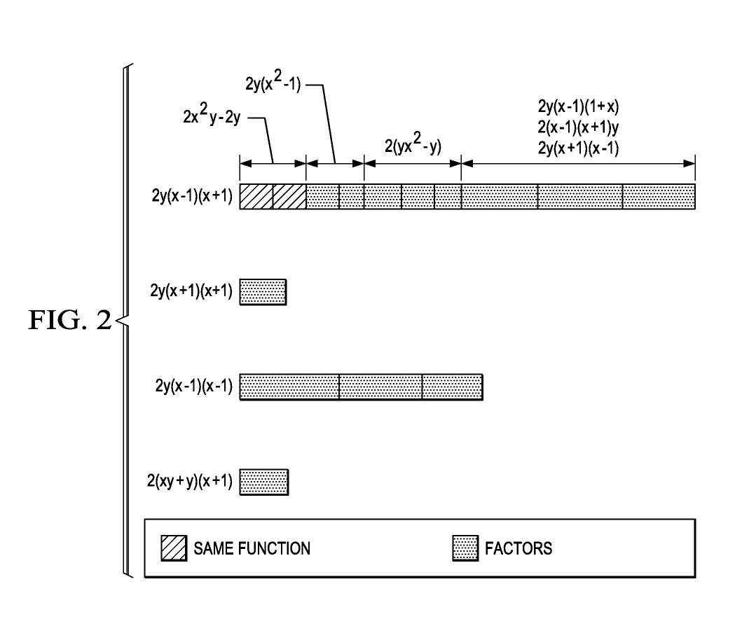

FIG. 2 is another embodiment of an aggregation of data in accordance with the present invention. FIG. 2 depicts a different possible display of the information derived from the same analysis described above. The difference here is that each bar on the histogram shows mathematically equivalent expressions, regardless of how they are factored or whether they are even factored at all. Rather such distinctions are shown graphically in a different way, by divided bars shown by parentheses. Differences in format alone, which carry no essential mathematical significance, are indicated, as in FIG. 1, by vertical markers within the bars.

In one embodiment, the teacher may wish to search for individual factors. Generally speaking, there are many alternate pedagogical methods a teacher might wish to use for specific instructional purposes. In addition, the automatic aggregation as described above, whereby a teacher can use such a facility for identifying equivalent factors. For example, a teacher may wish to promote discussion of whether or not certain groups of factors are indeed equivalent. That is, the teacher may select a factor of interest, perhaps from a list, or from a standard text-binned histogram, and do a “smart search” for mathematically equivalent factors. If any are found then they may be highlighted in a list view, or sections of multiple bars in a text-binned histogram may be highlighted.

In another embodiment, there may be a need to search for equivalent combinations of factors. For example, a teacher may wish to highlight the similarity between a common partially factored answer to a problem and the correct fully factored answer. The teacher can select either answer, move it to the smart search box, select “equivalent combinations of factors” and hit search. Then, all the common answers will be highlighted.

In yet another embodiment, a teacher may wish to illustrate the similarities or differences between a common answer and the correct one. For example, on-line in front of the class, the teacher may select the two answers under consideration and can operate on them using, for example, CAS in various ways (e.g. add them, subtract them, divide, or multiply them). Then the patterns in student work implied by this operation can be applied and highlighted to show the effects, with the action(s) applied.

In yet another set of examples, the problem may require finding a linear equation for given problem descriptions. Illustrations of such problem types follow:
a. Write an equation in slope-intercept form
b. Write an equation from a graph
c. Write an equation of a line with the given slope and intercept
d. Given two points on a line write the equation of the line in slope-intercept form
e. Convert an equation from point-slope form to slope-intercept form
f. Convert an equation from slope-intercept form to point-slope form
g. Write an equation for the line that is parallel to the given line and passes through the given point
h. Write an equation for the line that is perpendicular to the given line and passes through the given point

So, in yet a further embodiment, to set a typical scenario in which a problem from one of the above problem types might be assigned and analyzed: (1) the teacher asks a question verbally, or writes it on the board, or directs students to answer a specific one from a textbook, or has it entered into the classroom network system software; (2) Students answer the question and send it in to the teacher's computer via a networked classroom system, over the internet (i.e. in a live geographically distributed online class). The students may answer the question, which has been activated on a remote server, for an online class which operates asynchronously with different students connecting at different times, a question which is part of a homework assignment operating on a web-based homework system, and/or via any other convenient means which provides response data to the teacher in electronic form; (3) The teacher selects “linear equations” from among several mathematical object types (or this may have been pre-selected in course curriculum software by the system); (4) The teacher selects the type of linear equation analysis appropriate to the problem under consideration:

For example, given a choice of the following four types of linear equation analyses:
a. Finding equivalent equations
b. Finding equations with the same slopes
c. Finding equations with the same intercepts
d. Finding equivalent equations expressed in the same form
   Then, a teacher might choose analysis “a” above if the problem type were one of the following
a. Find the linear equation for given problem descriptions
b. Write an equation from a graph
c. Write an equation of a line with the given slope and intercept
d. Write an equation for the line that is parallel to the given line and passes through the given point
e. Write an equation for the line that is perpendicular to the given line and passes through the given point

In general, we can determine the equivalence of two candidate equations F(x,y)=0 and G(x,y)=0 using basic CAS functionality. Starting from student linear equations that are in any form (standard, slope-intercept, point-slope, etc), we can arrive at an F(x,y)=0 by a simple transformation. For example, if the student submits y=3x+4, we get F(x,y)=3x+4−y=0.

In another example, the student may need to find equations with the same slopes. This analysis may be something a teacher would choose if the problem type were one of the following:
a. Write an equation in slope-intercept form
b. Write an equation from a graph
c. Write an equation of a line with the given slope and intercept
d. Given two points on a line write the equation of the line in slope-intercept form
e. Convert an equation from point-slope form to slope-intercept form
f. Write an equation for the line that is parallel to the given line and passes through the given point
g. Write an equation for the line that is perpendicular to the given line and passes through the given point

In another embodiment, there may be a need to find equations with the same intercepts. This analysis may be something a teacher might additionally or alternatively choose if the problem type were also any of those from the above list:

Whereas, to find equivalent equations expressed in the same form, this analysis may be something a teacher would choose if the problem type were one of the following:
a. Write an equation in slope-intercept form
b. Given two points on a line write the equation of the line in slope-intercept form
c. Convert an equation from point-slope form to slope-intercept form
d. Convert an equation from slope-intercept form to point-slope form

In one embodiment, the data is received after a teacher defines a problem. The data received is from calculators, and/or handheld computers, and/or laptops, and/or netbooks, and/or desktops, and/or smartphones, that are on a network. Intelligent parsing is performed on the data. A math engine is utilized by the parsing. The aggregation may be dependent on a problem type, which a teacher may choose, a sub-aggregation dependent on the aggregation, and a report may be generated. The teacher may choose to perform different aggregations on the data, dependent on the lesson, the class, or the like.

In one embodiment a task given to students is a Physics problem, “Carbon 14 decays radioactively at a constant annual rate of 0.0121%. Show that the half-life of carbon-14 is about 5728 years.” The data sent from students in many scientific problems, while not superficially mathematical, may nevertheless be decomposed into mathematical representations, algorithms, or combinations of such. In this case, the data received from students is likely to be a single equation, that may or may not be equivalent to the following:

$$\frac{1}{2} {Q}_{0} {Q}_{0} \begin{matrix}( 1 & {0.000121 )}^{t}\end{matrix}$$

This equation when solved for “t” yields 5728.14 years, but different students may express it in different forms, which are nevertheless mathematically equivalent to the equation above, such as:

$$\frac{1}{2} \begin{matrix}( 1 & {0.000121 )}^{t}\end{matrix}$$

$$0.5 \begin{matrix}( 1 & {0.000121 )}^{t}\end{matrix}$$

$$\frac{1}{2} {( 0.999879 )}^{t}$$

$$t \frac{log ( 0.5 )}{log ( 0.999879 )}$$

As such, they are identical to Case (a) in [0043] above. Thus, the aggregation is performed by procedures identical to those already described, with all the above answers being placed in a single bucket, and incorrect answers in other buckets corresponding to their mathematically equivalent counterparts.

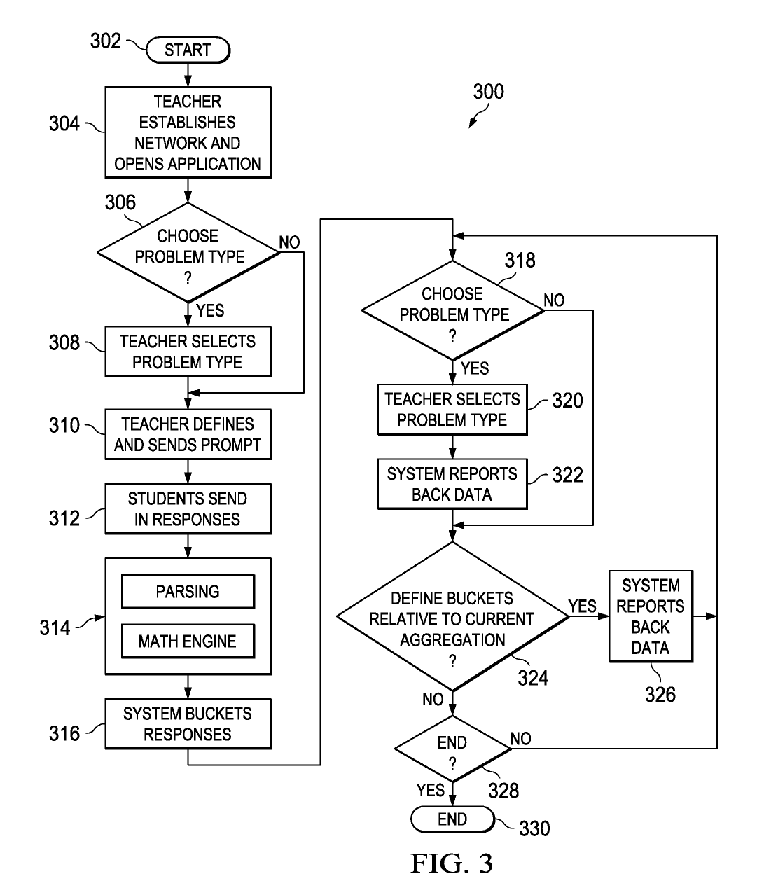

FIG. 3 depicts an embodiment of a method 300 for manipulating and aggregating student responses for instructional purposes. The method 300 starts at step 302 and proceeds to step 304. At step 304, the teacher may establish a network connection and opens an application to allow for classroom data exchange. At step 306, the method 300 determined if the teacher chooses a problem type; examples of problem types are defined above. If the teacher chooses the problem type, the method 300 proceeds to step 308, wherein the teacher's problem type is selected; otherwise, the method 300 proceeds to step 310. At step 310, the teacher defines and sends a prompt, such as, a character, combination of characters, word, phrase, sentence, or longer text, representing a sign, request, or instruction to students. At step 312, the students send in a response. At step 314, the method 300 parses and utilizes a math engine to prepare for response bucketing. If a problem type was chosen by the teacher at step 308, then the bucketing analyses performed at step 314 is cognizant of the requirements consonant with this problem type. If a problem type was not chosen at step 308, then the method 300 selects buckets characterized by the structure of the mathematical or scientific objects submitted as responses by the students.

At step 316, the method 300 buckets the responses. At step 317, the system reports back data. At step 318, the method 300 determines if the problem type is to be selected. In this way, the method 300 permits a teacher to iterate using different analyses reflective of alternate problem types, in order to gain insight into possible student thinking. If the problem type is to be chosen, the method 300 proceeds to step 320, wherein the teacher selects the problem type. The method 300 may parse and utilize a math engine to switch to the new problem type. From step 320, the method proceeds to step 322, wherein the method 300 reports the new problem type and the new analysis results and then proceeds to step 324.

If the problem type is not to be selected, the method 300 proceeds to step 324. At step 324, the method 300 allows the teacher to determine if additional buckets are needed for pedagogical purposes relative to the current aggregation. For example, such as those described earlier in [0038-0040]. If additional buckets are needed, the method 300 proceeds to step 325, wherein the method 300 allows the teacher to select criteria for the new buckets. Whereupon the method 300 parses and utilizes a math engine to prepare for response bucketing and reports the data 326; otherwise, the method 300 proceeds to step 328. If an alternate analysis based on a different problem type is needed the method 300 proceeds to step 318 and hence to 320, where the method 300 may parse that data and utilize a math engine for determining the buckets. From step 326, the method 300 proceeds to step 318. At step 328, the method 300 allows the teacher to determine if further aggregation analysis is needed. If it is not the procedure is ended, and the method 300 proceeds to step 330; otherwise, the method 300, proceeds to step 330. The method 300 ends at step 330.

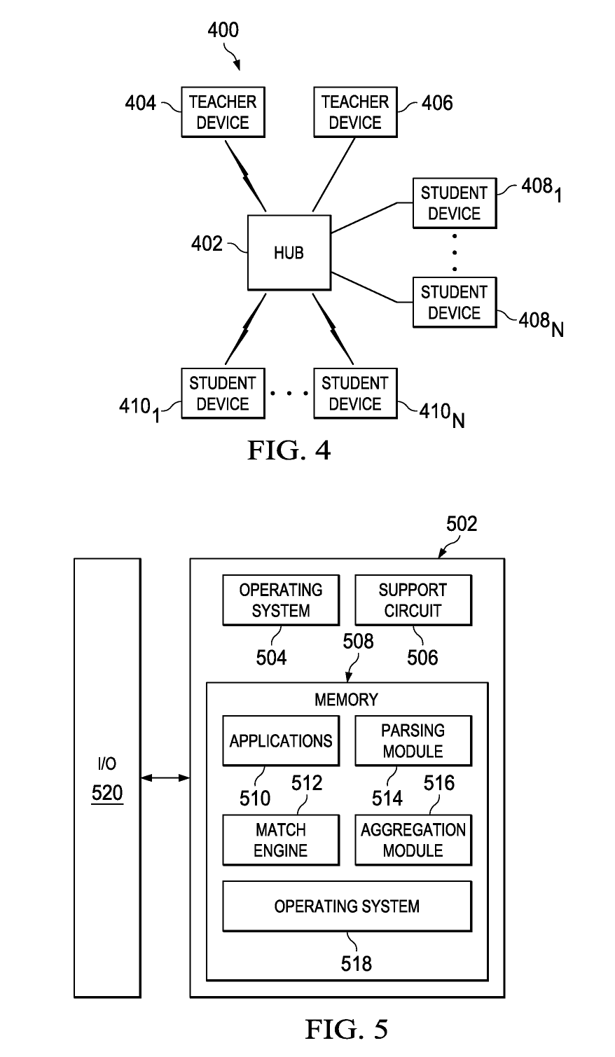

FIG. 4 depicts an embodiment of a system 400 for aggregating data for instructional purposes. The system 400 includes a hub 402, wireless teacher device 404, teacher device 406, student device 408 (408₁-408_{N}) and wireless student device 410 (410₁-410_{N}). The hub 402 facilitates communication between the student devices 408, 410 and the teacher devices 404, 406. The hub 402 may be a personal computer, a laptop, a handheld device or the like. The hub 402 may be utilized as a teacher device or a student device or maybe a dedicated hub for creating a network or facilitating communication. The student devices 408, 410 and the teacher devices 404, 406 may be a personal computer, a laptop, a handheld device or the like.

The wireless teacher device 404 is capable of communicating wirelessly with the hub 402 and the student devices 408. The teacher device 404, 406 is capable of communicating with the hub 402 and the student devices 408. If should be noted that the system 400 may include one of a wireless teacher device 404 or a teacher device 404; furthermore, the wireless teacher device 404 and a teacher device 406 maybe combined into the same device that may be utilized wireless or directly coupled to the hub 402. The system 400 may include any number of wireless teacher device 404 or the teacher device 406. The teacher utilizes the teacher device 404, 406 to prompt the students and to receive students' responses via the hub 402 and/or the teacher device 404, 406.

The wireless student device 410 is capable of communicating wirelessly with the hub 402 and the teacher device 404, 406. The student device 408, 410 is capable of communicating with the hub 402 and the student device 408. If should be noted that the system 400 may include one of a wireless student device 410 or a student device 408; furthermore, the wireless student device 410 and a student device 408 maybe combined into the same device that may be utilized wireless or directly coupled to the hub 402. The system 400 may include any number of wireless student device 410 or the student device 408. The student utilizes the student device 408, 410 to respond and to communicate with the teacher, and to receive teachers' prompt.

FIG. 5 depicts and embodiment of an apparatus 502 for aggregating data for instructional purposes. The apparatus 502 includes a central processing unit (CPU) 504, support circuit 506 and memory 508. The CPU 502 may comprise one or more conventionally available microprocessors. The microprocessor may be an application specific integrated circuit (ASIC). The support circuits 506 are well known circuits used to promote functionality of the CPU 504. Such circuits include, but are not limited to, a cache, power supplies, clock circuits, input/output (I/O) devices 520 and the like.

The memory 508 may comprise random access memory, read only memory, removable disk memory, flash memory, and various combinations of these types of memory. The memory 508 is sometimes referred to main memory and may, in part, be used as cache memory or buffer memory. The memory 508 may store an operating system (OS) 518, various forms of application 510, a math engine 512, a parsing module 514 and an aggregate module 516. The aggregate module 516 performs any of the methods described in FIG. 3, 4 and/or 5.

The foregoing embodiments are not intended to represent exhaustive compilations of all possible types of mathematical data and aggregations for instructional purposes. Mathematics and science are a vast fields, so it is clearly not feasible to include all possible such descriptions. The foregoing examples are intended solely for illustrative purposes, and the invention should not be considered as limited thereto or thereby. Various modifications within the spirit and scope of the invention will be apparent to ordinarily skilled artisans. Thus, while the foregoing is directed to embodiments of the present invention, other and further embodiments of the invention may be devised without departing from the basic scope thereof, and the scope thereof is determined by the claims that follow.

What is claimed is:

1. A method for presenting aggregated data for instructional purposes, the method comprising:
retrieving student responses;
determining at least one bucket type and, if needed, changing the algorithmic criteria defining the at least one bucket type;
aggregating the responses according to bucket type; and
utilizing the aggregated responses for instructional purposes.

2. The method of claim 1, wherein the step of aggregating the responses comprises at least one of parsing the response or utilizing a math engine.

3. The method of claim 2, wherein the math engine is a CAS engine.

4. The method of claim 1, wherein the method is performed in real-time as the student's response is being retrieved.

5. The method of claim 1, wherein the responses are being retrieved from at least one of a calculator, a handheld computer, a laptop computer, a notebook computer, a desktop computer, a tablet computer, a cellphone, or a media player.

6. The method of claim 1, wherein the bucket type relates to an environment.

7. The method of claim 6, wherein the environment is at least one of symbolic, graphical, geometric, coordinate grid, model, algebra tiles, chemical equation, vector diagram, molecular model, biological model, physics model, chemical model, geological model, astronomical model, economics model, or business model.

8. The method of claim 1, wherein the responses are in at least one of symbolic form, algebraic steps, algebraic expression, equation, graphic form, graphic construction, or model form.

9. The method of claim 1, wherein the responses are triggered by a teacher's prompt.

10. The method of claim 1 further comprising repeating the steps to view the aggregation in different environments.

11. The method of claim 1, wherein the responses are retrieved over at least one of a dedicated wired or wireless network, the internet from a “virtual” classroom, the internet via a “homework” system, or the internet asynchronously in a distance learning context.

12. An apparatus for presenting aggregated data for instructional purposes, the comprising:
means for retrieving student responses;
means for determining at least one bucket type and, if needed, changing the algorithmic criteria defining the at least one bucket type;
means for aggregating the responses according to bucket type; and
means for utilizing the aggregated responses for instructional purposes.

13. The apparatus of claim 12, wherein the means for changing algorithmic criteria comprises at least one of means for parsing the response or means for utilizing a math engine.

14. The apparatus of claim 13, wherein the math engine is a CAS engine.

15. The apparatus of claim 12, wherein the apparatus is utilized in real-time as the student's response is being retrieved.

16. The apparatus of claim 12, wherein the responses are being retrieved from at least one of a calculator, a handheld computer, a laptop computer, a notebook computer, a desktop computer, a tablet computer, a cellphone, or a media player.

17. The apparatus of claim 12, wherein the bucket type relates to an environment.

18. The apparatus of claim 17, wherein the environment is at least one of symbolic, graphical, geometric, coordinate grid, model, or algebra tiles, chemical equation, vector diagram, molecular model, biological model, physics model, chemical model, geological model, astronomical model, economics model, or business model.

19. The apparatus of claim 12, wherein the responses are in at least one of symbolic form, algebraic steps, algebraic expression, equation, graphic form, graphic construction, or model form.

20. The apparatus of claim 12, wherein the responses are triggered by a teacher's prompt.

21. The apparatus of claim 12 further comprising repeating the steps to view the aggregation different environments.

22. The apparatus of claim 12, wherein the responses are retrieved over at least one of a dedicated wired or wireless network, the internet from a “virtual” classroom, the internet via a “homework” system, or the internet asynchronously in a distance learning context.

22. A computer readable medium, comprising executable instructions, when executed, perform a method for presenting aggregated data for instructional purposes, the method comprising:
retrieving student responses;
determining at least one bucket type and, if needed, changing the algorithmic criteria defining the at least one bucket type;
aggregating the responses according to bucket type; and
utilizing the aggregated responses for instructional purposes.

23. The computer readable medium of claim 22, wherein the step of changing the responses comprises at least one of parsing the response or utilizing a math engine.

24. The computer readable medium of claim 23, wherein the math engine is a CAS engine.

25. The computer readable medium of claim 22, wherein the method if performed in real-time as the student's response is being retrieved.

26. The computer readable medium of claim 22, wherein the responses are being retrieved from a student's calculator.

27. The computer readable medium of claim 22, wherein the bucket type relates to an environment.

28. The computer readable medium of claim 26, wherein the environment is at least one of symbolic, graphical, geometric, coordinate grid, model, or algebra tiles, chemical equation, vector diagram, molecular model, biological model, physics model, chemical model, geological model, astronomical model, economics model, or business model.

29. The computer readable medium of claim 22, wherein the responses are in at least one of symbolic form, algebraic steps, algebraic expression, equation, graphic form, graphic construction, or model form.

30. The computer readable medium of claim 22, wherein the responses are triggered by a teacher's prompt.

31. The computer readable medium of claim 22 further comprising repeating the steps to view the aggregation different environments.

32. The computer readable medium of claim 31, wherein the responses are being retrieved over at least one of: a dedicated wired or wireless network, the internet from a “virtual” classroom, the internet via a “homework” system, or the internet asynchronously in a distance learning context.
